(19) United States
(12) Patent Application Publication
(10) Pub. No.: US 2012/0263478 A1
(43) Pub. Date: Oct. 18, 2012

(54) HEARING AID SYSTEM USING WIRELESS OPTICAL COMMUNICATIONS

(76) Inventor: Dong Soo JANG, Gwangju (KR)

(21) Appl. No.: 13/443,831

(22) Filed: Apr. 10, 2012

(30) Foreign Application Priority Data
Apr. 15, 2011 (KR) 10-2011-0035346

(51) Int. Cl. H04R 25/00; H04B 10/02

(52) U.S. Cl. 398/133

(57) ABSTRACT

Provided is a hearing aid system using a wireless optical communications method. The hearing aid system includes: a voice transmitter that converts addresser's voice into an optical signal to then transmit the converted optical signal; and a hearing aid that restores the optical signal received from the voice transmitter into the addresser's voice to then output the restored addresser's voice. Accordingly, the addresser's voice can directly be transmitted to the hard-of-hearing via wireless optical communications, to thereby prevent a voice discriminating power from lowering even in the case that ambient noise of an addresser as well as a listener is big.

### CROSS-REFERENCE TO RELATED APPLICATION

This application claims the benefit of Korean Patent Application No. 10-2011-0035346, filed on Apr. 15, 2011, in the Korean Intellectual Property Office, the disclosure of which is incorporated herein by reference.

### BACKGROUND OF THE INVENTION

1. Field of the Invention

The present invention relates to a hearing aid system, and more particularly to a hearing aid system that amplifies the addresser's voice to then output the amplified addresser's voice so that a person who has difficulty in hearing (hereinafter will be referred to as the hard-of-hearing) can listen to the addresser's voice.

2. Description of the Related Art

Currently developed or commercially available hearing aids are typically composed of a microphone, a signal processor and a speaker, respectively. The microphone converts the addresser's voice into an electrical sound signal, the signal processor amplifies the electrical sound signal output from the microphone, and the speaker converts the sound signal that has been amplified and output from the signal processor into the addresser's voice, to then output the addresser's voice.

The hearing aids can compensate for the reduced hearing threshold of the hard-of-hearing. However, since the hearing aids collect, amplify and output surrounding noise as well as the addresser's voice, the hard-of-hearing may not easily discriminate the addresser's voice. As a result, the hard-of-hearing may not listen to the addresser's voice and may have the difficulty in understanding the addresser's voice even though he or she has listened to the addresser's voice.

### SUMMARY OF THE INVENTION

To solve the above conventional problems or defects, it is an object of the present invention to provide a hearing aid system that transmits the addresser's voice to the hard-of-hearing via a wireless optical communications method in order to prevent an addresser's voice discriminating power of the hard-of-hearing from being lowered by ambient noise.

To accomplish the above and other objects of the present invention, according to an aspect of the present invention, there is provided a hearing aid system comprising:

a voice transmitter that converts addresser's voice into an optical signal to then transmit the converted optical signal; and

a hearing aid that restores the optical signal received from the voice transmitter into the addresser's voice to then output the restored addresser's voice,

wherein the voice transmitter comprises:

a first microphone that converts the addresser's voice into a first sound signal;

a second microphone converts the addresser's voice into a second sound signal;

a voice transmitter signal processor that amplifies one of the first sound signal applied from the first microphone and the second sound signal applied from the second microphone;

a light emitter that converts the amplified sound signal applied from the voice transmitter signal processor into the optical signal to then transmit the converted optical signal; and

a voice transmitter switch that selects one of the first and second microphones, as a microphone that provides the sound signal to be amplified in the signal processor.

Preferably but not necessarily, the first microphone is exposed to the outside of the voice transmitter, and the second microphone is not exposed to the outside of the voice transmitter.

Preferably but not necessarily, one of the first microphone and one end of the second microphone are connected to electric power terminals of the voice transmitter signal processor.

Preferably but not necessarily, the voice transmitter is implemented into any one of types that the voice transmitter is inserted into the addresser's ear, the voice transmitter is hung around the addresser's ear, and the voice transmitter is portable by the addresser.

Preferably but not necessarily, the hearing aid comprises:

a light receptor that converts the optical signal received from the voice transmitter into the sound signal to then output the converted sound signal;

a third microphone that converts the addresser's voice into a third sound signal;

a hearing aid signal processor that amplifies one of the sound signal applied from the light receptor and the third sound signal applied from the third microphone;

a speaker that converts the amplified sound signal applied from the hearing aid signal processor into the voice to then output the converted voice; and

a hearing aid switch that selects one of the light receptor and the third microphone, as a microphone that provides the sound signal to be amplified in the hearing aid signal processor.

Preferably but not necessarily, the light receptor and the third microphone are exposed to the outside of the hearing aid, and the speaker is not exposed to the outside of the hearing aid.

Preferably but not necessarily, the hearing aid further comprises a controller that controls an amplification range of the sound signal in the hearing aid signal processor.

Preferably but not necessarily, the hearing aid is implemented into any one of types that the hearing aid is inserted into the hard-of-hearing's ear, the hearing aid is hung around the hard-of-hearing's ear, and the hearing aid is portable by the hard-of-hearing.

According to another aspect of the present invention, there is provided an addresser's voice transmitter comprising:

a first microphone that converts the addresser's voice into a first sound signal;

a second microphone converts the addresser's voice into a second sound signal;

a voice transmitter signal processor that amplifies one of the first sound signal applied from the first microphone and the second sound signal applied from the second microphone;

a light emitter that converts the amplified sound signal applied from the voice transmitter signal processor into the optical signal to then transmit the converted optical signal; and

a voice transmitter switch that selects one of the first and second microphones, as a microphone that provides the sound signal to be amplified in the signal processor.

According to still another aspect of the present invention, there is provided a hearing aid comprising:

a light receptor that converts a received optical signal into a first sound signal to then output the converted sound signal;

a hearing aid microphone that converts addresser's voice into a second sound signal;

a hearing aid signal processor that amplifies one of the first sound signal applied from the light receptor and the second sound signal applied from the hearing aid microphone;

a speaker that converts the amplified sound signal applied from the hearing aid signal processor into the voice to then output the converted voice; and

a hearing aid switch that selects one of the light receptor and the hearing aid microphone, as a microphone that provides the sound signal to be amplified in the hearing aid signal processor.

### ADVANTAGEOUS EFFECTS

As described above, according to the present invention, the addresser's voice can directly be transmitted to the hard-of-hearing via wireless optical communications, to thereby prevent a voice discriminating power from lowering even in the case that ambient noise of an addresser as well as a listener is big.

In addition, the present invention provides an advantage that the addresser can selectively use two microphones that are provided in different areas of a voice transmitter, to thereby select a microphone having an excellent voice transmission performance.

In addition, in an area with low ambient noise, a microphone that is provided in the hearing aid can be selectively used, in which case the voice transmitter is not necessary to thus enhance convenience of the addresser.

In addition, since the hearing aid's microphone is not used at the time of transmitting voice via the wireless optical communications, an acoustic feedback (that is, a howling effect) in the hearing aid due to interaction between the microphone and the speaker may be blocked.

Further, since a light-emitting device and a light-receiving device are operated by a PCM (Pulse Code Modulation) method of an ON/OFF operation, the present invention provides an advantage that electric power consumption is small and communication noise is very low, in comparison with radio frequency communications.

In addition, the present invention has an excellent effect that a voice transmission speed is very fast because of using a wireless optical communications method.

Meanwhile, since the operating threshold voltage of the light-emitting device and the light-receiving device is about 1V, there is no trouble in implementing an electric power supply of 1.4V for use in a normal hearing aid.

### BRIEF DESCRIPTION OF THE DRAWINGS

FIG. 1 is a diagram illustrating a situation where an addresser and a hard-of-hearing converse each other by using a hearing aid system according to an embodiment of the present invention.

FIG. 2 is a perspective view showing the external appearance of a voice transmitter shown in FIG. 1.

FIG. 3 is a cross-sectional view cut along the center of the voice transmitter shown in

FIG. 2.

FIG. 4 is a detailed block diagram of the voice transmitter shown in FIG. 2.

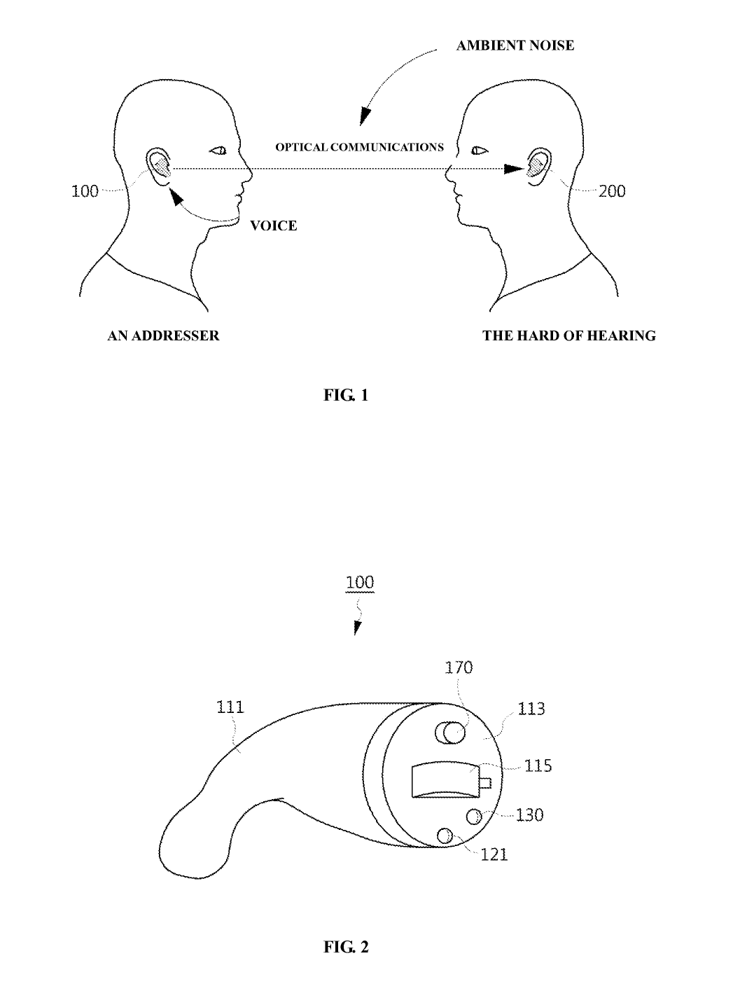

FIG. 5 is a perspective view showing the external appearance of a hearing aid shown in FIG. 1.

FIG. 6 is a cross-sectional view cut along the center of the hearing aid shown in FIG. 5.

FIG. 7 is a detailed block diagram of the hearing aid shown in FIG. 5.

FIG. 8 is a diagram showing a relative radiation directivity between a light-emitting device and a light-receiving device.

FIG. 9 is a perspective view illustrating an earring shaped voice transmitter or hearing aid.

FIG. 10 is a diagram illustrating a pocket-sized voice transmitter or hearing aid.

### DETAILED DESCRIPTION OF THE INVENTION

The above and/or other objects and/or advantages of the present invention will become more apparent by the following description.

The hearing aid system according to a preferred embodiment of the present invention will be described below with reference to the accompanying drawings.

1. Hearing Aid System

FIG. 1 is a diagram illustrating a situation where an addresser and a hard-of-hearing converse each other by using a hearing aid system according to an embodiment of the present invention. As shown in FIG. 1, the hearing aid system according to this embodiment includes a voice transmitter 100 that is inserted into an addresser's ear, and a hearing aid 200 that is inserted into a hard-of-hearing's ear. Here, the ‘addresser’ is a person who vocalizes voice with a normal hearing ability, and the hard-of-hearing is a person who has a weak hearing ability to thus have the difficulty in hearing the addresser's voice. The voice transmitter 100 converts the addresser's voice into an optical signal and transmits the converted optical signal to the hearing aid 200, and the hearing aid 200 restores the optical signal received from the voice transmitter 100 into the addresser's voice to then output the restored addresser's voice.

As described above, since the addresser's voice is transmitted to the hard-of-hearing through a wireless optical communications method in the hearing aid system according to this embodiment of the present invention, an effect of ambient noise can be eliminated. Hereinbelow, the structural configuration of the voice transmitter 100 and the hearing aid 200 will be described in detail.

2. Voice Transmitter

FIG. 2 is a perspective view showing the external appearance of a voice transmitter 100 shown in FIG. 1. As shown in FIG. 2, the external appearance of the voice transmitter 100 includes an earshell 111 and a faceplate 113. A light-emitting device 170, a battery door 115, a voice transmitter switch 130 and a first microphone 121 are provided on the faceplate 113.

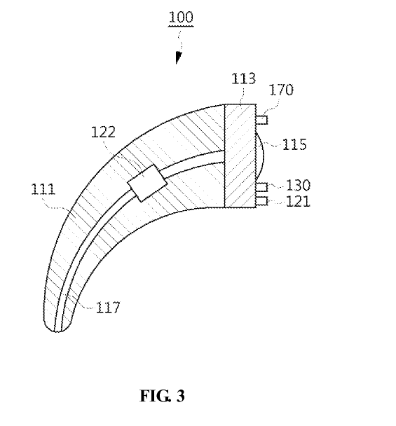

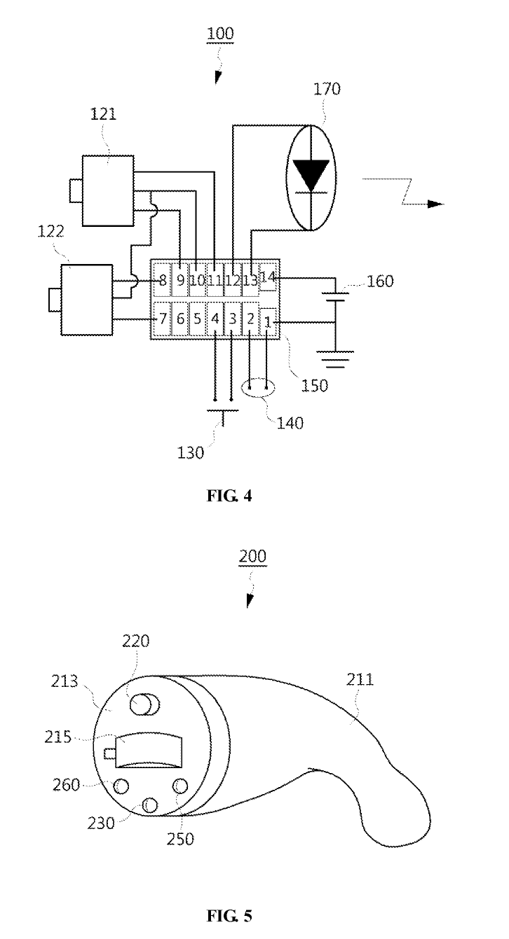

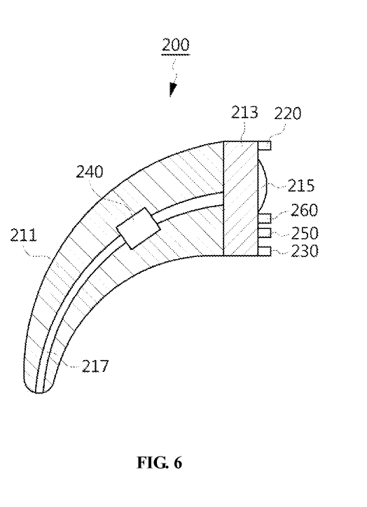

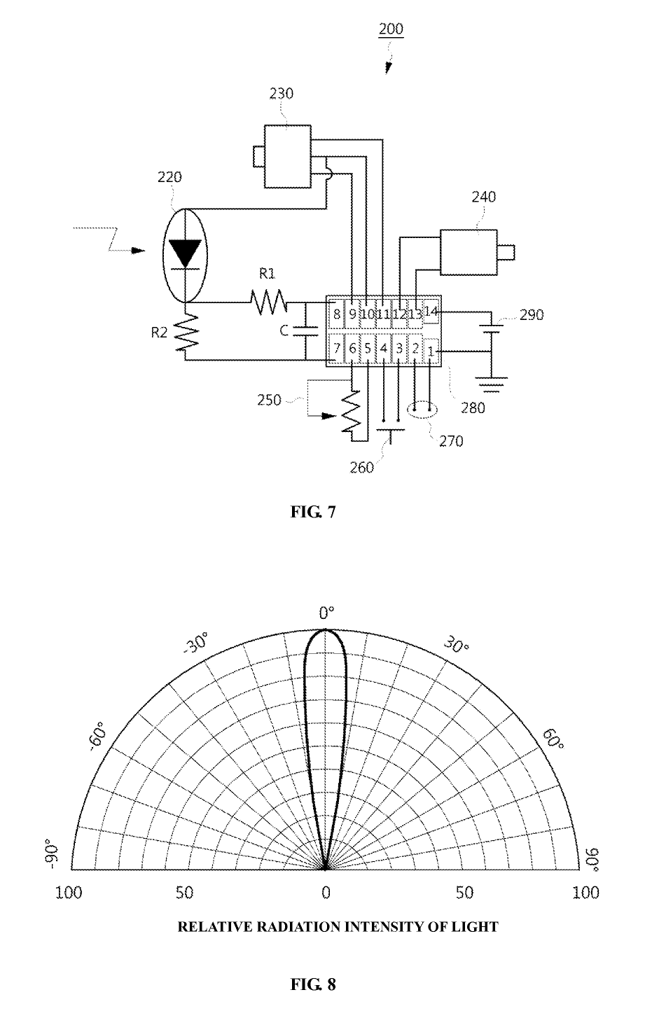

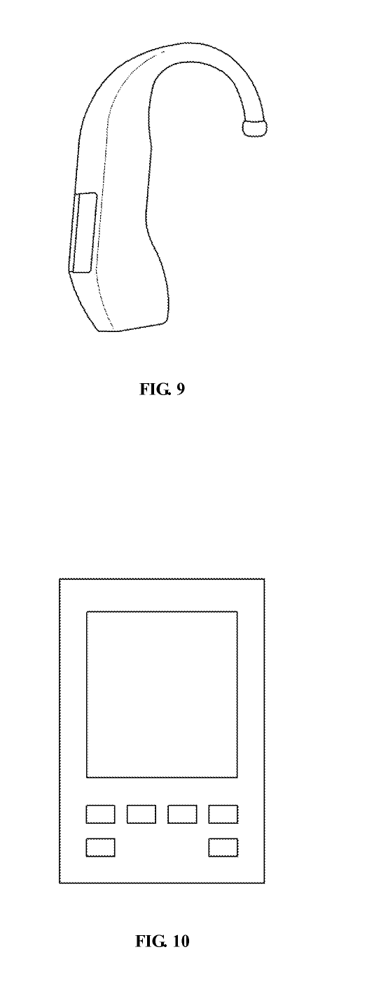

FIG. 3 is a cross-sectional view cut along the center of the voice transmitter 100 shown in FIG. 2. Referring to FIG. 3, it can be seen that a second microphone 122 connected with a microphone tube 117 is provided in the inner-center of the voice transmitter 100.

FIG. 4 is a detailed block diagram of the voice transmitter 100 shown in FIG. 2. As shown in FIG. 4, the voice transmitter 100 is equipped with the first microphone 121, the second microphone 122, the voice transmitter switch 130, an external device interface terminal portion 140, a voice transmitter signal processor 150, a battery 160 and a light-emitting device 170. The first microphone 121 collects the addresser's voice and converts the collected addresser's voice into an electrical sound signal. It can be seen from FIG. 2 that the first microphone 121 is exposed to the outside through the faceplate 113 of the voice transmitter 100. The second microphone 122 is identical with the first microphone 121 in a point of view that the second microphone 122 also collects the addresser's voice and converts the collected addresser's voice into an electrical sound signal. However, as shown in FIG. 3, the second microphone 122 differs from the first microphone 121 in a point of view that the second microphone 122 is provided in the inside of the earshell 111 and is not exposed to the outside.

The voice transmitter signal processor 150 amplifies one of the sound signal applied from the first microphone 121 and the sound signal applied from the second microphone 122. The sound signal amplified by the voice transmitter signal processor 150 is determined by the voice transmitter switch 130. The voice transmitter switch 130 is a means for selecting a microphone that applies a sound signal to be amplified in the voice transmitter signal processor 150. The voice transmitter switch 130 is implemented into a touch type toggle button switch. As a result, the first microphone 121 and the second microphone 122 can be selected in turn as a microphone that applies a sound signal to be amplified in the voice transmitter signal processor 150 whenever the addresser presses the button switch 130.

Meanwhile, terminals 9, 10, and 11 of the voice transmitter signal processor 150 are microphone input terminals, and terminals 7 and 8 thereof are audio input terminals. In this embodiment, the audio input terminals as well as the microphone input terminals are used to connect two microphones 121 and 122 with the voice transmitter signal processor 150. In other words, the first microphone 121 is connected to the terminals 9, 10, and 11 that are the microphone input terminals of the voice transmitter signal processor 150, and the second microphone 122 is connected to the terminals 7 and 8 that are the audio input terminals of the voice transmitter signal processor 150.

The sound signals that are generated by the first and second microphones 121 and 122 are very small in a unit of micro-volts. Therefore, the first and second microphones 121 and 122 pre-amplify the generated sound signals to then output the pre-amplified sound signals, respectively. A direct-current (DC) offset voltage necessary for pre-amplification is supplied from the voice transmitter signal processor 150. The microphone input terminals 9, 10, and 11 of the voice transmitter signal processor 150 are a signal terminal, an electric power terminal and a ground terminal, respectively. The first microphone 121 receives the DC offset voltage through the terminal 10 of the voice transmitter signal processor 150. The audio input terminals 7 and 8 of the voice transmitter signal processor 150 are a signal terminal and a ground terminal, respectively.

Unlike a microphone, sound signals that are output from an audio device are so large that there is no electric power terminal in audio input terminals. However, the sound signals generated by the second microphone 122 that is connected to the audio input terminals requires for pre-amplification. Accordingly, in this embodiment, the terminal 10 of the voice transmitter signal processor 150 is also connected to the second microphone 122, to thus enable the second microphone 122 to receive the DC offset voltage through the terminal 10 of the voice transmitter signal processor 150. The light-emitting device 170 converts the sound signal amplified by the signal processor 150 into an optical signal to then transmit the converted optical signal. For example, the light-emitting device 170 can be implemented into an LED (Light-Emitting Diode) device. The light-emitting device 170 has a digital switching function that emits light above a threshold voltage of 1V or high and does not emit light below the threshold voltage less than 1V, at the threshold voltage of 1V typically. In addition, the sound signal that is output from the voice transmitter signal processor 150 is a digital PCM (Pulse Code Modulation) signal. Thus, the light-emitting diode 170 is turned on and then off to thereby transmit an optical signal depending on a digital logic level ‘0’ and ‘1’ of the sound signal output from the voice transmitter signal processor 150. In this process, since the light-emitting diode 170 is continuously turned on but is repeatedly turned on and off, an electric power consumption is dramatically reduced. The external device interface terminal portion 140 includes terminals for interfacing with an external device such as a computer. The voice transmitter signal processor 150 can be controlled by the external device through the external device interface terminal portion 140, and a software program that may be required to run the voice transmitter signal processor 150 can be mounted in the voice transmitter signal processor 150 through the external device interface terminal portion 140.

The battery 160 supplies necessary electric power for the components 121, 122, 150 and 170 that are provided in the voice transmitter 100 shown in FIG. 4.

As described above, the first microphone 121 is exposed to the outside of the faceplate 113 and the second microphone 122 is provided in the inner-center of the voice transmitter 100 and is not exposed to the outside of the voice transmitter 100. Thus, if there is a lot of ambient noise, is preferable to choose the second microphone 122 in order to block the much noise.

Meanwhile, since the voice transmitter 100 has no speaker, an acoustic feedback does not only occur but also since the length of the earshell 111 is short and thus the earshell 111 is not inserted into the addresser's ear, discomfort that the addresser feels during wearing the earshell 111 can be minimized. In addition, the addresser can hear the external sound through the other ear where the voice transmitter 100 has not been worn.

3. Hearing Aid

FIG. 5 is a perspective view showing the external appearance of a hearing aid 200 shown in FIG. 1. As shown in FIG. 5, The external appearance of the hearing aid 200 includes an earshell 211 and a faceplate 213. A light-receiving device 220, a battery door 215, a hearing aid switch 260, a third microphone 230, and a volume control 250 are provided on the faceplate 213.

FIG. 6 is a cross-sectional view cut along the center of the hearing aid 200 shown in FIG. 5. Referring to FIG. 6, it can be seen that a speaker 240 connected by a speaker tube 217 is provided at the inner-center of the hearing aid 200.

FIG. 7 is a detailed block diagram of the hearing aid 200 shown in FIG. 5. As shown in FIG. 7, the hearing aid 200 is equipped with the light-receiving device 220, the third microphone 230, the speaker 240, the volume control, 250, the hearing aid switch 260, an external device interface terminal portion 270, a hearing aid signal processor 280 and a battery 290. The light-receiving device 220 converts the optical signal transmitted from the light-emitting device 170 of the voice transmitter 100 into an electrical sound signal to then output the converted electrical sound signal. For example, the light-receiving device 220 may include a light-receiving diode. The sound signal output from the light-receiving device 220 is transferred to the hearing aid signal processor 280 through a low-pass filter formed of a capacitor C1 and resistors R1 and R2. The third microphone 230 converts the addresser's voice into an electrical sound signal. It can be seen from FIG. 5 that the third microphone 230 is exposed to the outside through the faceplate 213 of the hearing aid 200.

The sound signal that is generated by the third microphone 230 is very small in a unit of micro-volts. Therefore, the third microphone 230 pre-amplifies the generated sound signal to then output the pre-amplified sound signal. A direct-current (DC) offset voltage necessary for pre-amplification is supplied from the hearing aid signal processor 280. Specifically, the microphone input terminals 9, 10, and 11 of the hearing aid signal processor 280 are a signal terminal, an electric power terminal and a ground terminal, respectively. The third microphone 230 receives the DC offset voltage through the terminal 10 of the hearing aid signal processor 280.

The hearing aid signal processor 280 amplifies one of the sound signal applied from the light-receiving device 220 and the sound signal applied from the third microphone 230.

The sound signal amplified by the hearing aid signal processor 280 is determined by the hearing aid switch 260. The hearing aid switch 260 is a means for selecting a source that applies a sound signal to be amplified in the hearing aid signal processor 280. The hearing aid switch 260 is implemented into a touch type toggle button switch. As a result, the light-receiving device 220 and the third microphone 230 can be selected in turn as a source that applies a sound signal to be amplified in the hearing aid signal processor 280 whenever the addresser presses the button switch 260.

In another embodiment, the hearing aid signal processor 280 may automatically choose a source that provides a sound signal to be amplified. For example, in the case that the signal level of the optical signal received via the light-receiving device 220 is beyond a threshold value (for example, in the case that the signal level of the optical signal is lower or higher than the threshold value), the hearing aid signal processor 280 outputs a guiding message that will change the sound signal source to thus automatically choose the third microphone 230 as the source that provides the sound signal. Alternatively, in the case that the PCM signal of the optical signal received via the light-receiving device 220 is received as an error pattern as in the case an identical pattern is repeated for a certain period of time, the hearing aid signal processor 280 outputs a guiding message that will change the sound signal source to thus automatically choose the third microphone 230 as the source that provides the sound signal. The error pattern is pre-defined to then be input to the hearing aid signal processor 280.

The speaker 240 converts the sound signal amplified and applied from the hearing aid signal processor 280 into the addresser's voice to then output the converted addresser's voice.

The sound signal applied from the hearing aid signal processor 280 to the speaker 240 may not be an analog signal but may be a digital PCM (Pulse Code Modulation) signal. This is because the internal resistor and capacitor components of the speaker 240 act as a low-pass filter, to thus convert the digital PCM signal into the analog signal in the speaker 240 itself.

The volume control 250 controls the hearing aid signal processor 280 to adjust the amplification factor of the sound signal to thus ultimately adjust the size of the output of the speaker 240.

The external device interface terminal portion 270 includes terminals for interfacing with an external device such as a computer. The hearing aid signal processor 280 can be controlled by the external device through the external device interface terminal portion 270, and a software program that may be required to run the hearing aid signal processor 280 can be mounted in the hearing aid signal processor 280 through the external device interface terminal portion 270. The battery 290 supplies necessary electric power for the components 220, 230, 240 and 280 that are provided in the hearing aid 200 shown in FIG. 7.

4. Others

The distance between the addresser and the hard-of-hearing may be acceptable if the optical signal transmitted from the light-emitting device 170 may sufficiently stimulate the light-receiving device 220, and is typically very long as 10 meters. As shown in FIG. 8, this is because a relative radiation directivity between the light-emitting device 170 and the light-receiving device 220 is small as 10 degrees. In order to make the distance between the addresser and the hard-of-hearing a little longer, the output current of the signal processor 150 that is provided in the voice transmitter 100 should be made to increase.

In the above-described embodiment, the voice transmitter 100 has been described in the form of an in-ear type, that is, a form that the voice transmitter 100 is inserted into the addresser's ear. This is nothing but illustrative for convenience of explanation. Thus, the voice transmitter 100 may be implemented into the other forms, for example, any one of types that the voice transmitter 100 is hung around the addresser's ear (see an earring type of FIG. 9), and the voice transmitter 100 is portable by the addresser (see a pocket-type of FIG. 10). Meanwhile, the hearing aid 200 has been described in the form of an in-ear type, that is, a form that the hearing aid 200 is inserted into the addresser's ear. This is nothing but illustrative for convenience of explanation. Thus, the hearing aid 200 may be implemented into the other forms, for example, any one of types that the hearing aid 200 is hung around the hard-of-hearing's ear (see an earring type of FIG. 9), and the hearing aid 200 is portable by the hard-of-hearing (see a pocket-type of FIG. 10). However, in the case of the pocket-type, the speaker should be replaced with the earphone.

Meanwhile, the above-described embodiments have been described with respect to the case of a single addresser, but the present invention can be applied even in the case of a plurality of addressers. In this case, however, the light-emitting device and the light-receiving device are required to use an identical optical frequency.

As described above, the present invention has been described with respect to particularly preferred embodiments. However, the present invention is not limited to the above embodiments, and it is possible for one who has an ordinary skill in the art to make various modifications and variations, without departing off the spirit of the present invention. Thus, the protective scope of the present invention is not defined within the detailed description thereof but is defined by the claims to be described later and the technical spirit of the present invention.

What is claimed is:

1. A hearing aid system comprising:
a voice transmitter that converts addresser's voice into an optical signal to then transmit the converted optical signal; and
a hearing aid that restores the optical signal received from the voice transmitter into the addresser's voice to then output the restored addresser's voice,
wherein the voice transmitter comprises:
a first microphone that converts the addresser's voice into a first sound signal;
a second microphone converts the addresser's voice into a second sound signal;
a voice transmitter signal processor that amplifies one of the first sound signal applied from the first microphone and the second sound signal applied from the second microphone;
a light emitter that converts the amplified sound signal applied from the voice transmitter signal processor into the optical signal to then transmit the converted optical signal; and
a voice transmitter switch that selects one of the first and second microphones, as a microphone that provides the sound signal to be amplified in the signal processor.

2. The hearing aid system according to claim 1, wherein the first microphone is exposed to the outside of the voice transmitter, and the second microphone is not exposed to the outside of the voice transmitter.

3. The hearing aid system according to claim 2, wherein one of the first microphone and one end of the second microphone are connected to electric power terminals of the voice transmitter signal processor.

4. The hearing aid system according to claim 1, wherein the voice transmitter is implemented into any one of types that the voice transmitter is inserted into the addresser's ear, the voice transmitter is hung around the addresser's ear, and the voice transmitter is portable by the addresser.

5. The hearing aid system according to claim 1, wherein the hearing aid comprises:
a light receptor that converts the optical signal received from the voice transmitter into the sound signal to then output the converted sound signal;
a third microphone that converts the addresser's voice into a third sound signal;
a hearing aid signal processor that amplifies one of the sound signal applied from the light receptor and the third sound signal applied from the third microphone;
a speaker that converts the amplified sound signal applied from the hearing aid signal processor into the voice to then output the converted voice; and
a hearing aid switch that selects one of the light receptor and the third microphone, as a microphone that provides the sound signal to be amplified in the hearing aid signal processor.

6. The hearing aid system according to claim 5, wherein the light receptor and the third microphone are exposed to the outside of the hearing aid, and the speaker is not exposed to the outside of the hearing aid.

7. The hearing aid system according to claim 5, wherein the hearing aid further comprises a controller that controls an amplification range of the sound signal in the hearing aid signal processor.

8. The hearing aid system according to claim 5, wherein the hearing aid is implemented into any one of types that the hearing aid is inserted into the hard-of-hearing's ear, the hearing aid is hung around the hard-of-hearing's ear, and the hearing aid is portable by the hard-of-hearing.

9. An addresser's voice transmitter comprising:
a first microphone that converts the addresser's voice into a first sound signal;
a second microphone converts the addresser's voice into a second sound signal;
a voice transmitter signal processor that amplifies one of the first sound signal applied from the first microphone and the second sound signal applied from the second microphone;
a light emitter that converts the amplified sound signal applied from the voice transmitter signal processor into the optical signal to then transmit the converted optical signal; and
a voice transmitter switch that selects one of the first and second microphones, as a microphone that provides the sound signal to be amplified in the signal processor.

10. A hearing aid comprising:
a light receptor that converts a received optical signal into a first sound signal to then output the converted sound signal;
a hearing aid microphone that converts addresser's voice into a second sound signal;
a hearing aid signal processor that amplifies one of the first sound signal applied from the light receptor and the second sound signal applied from the hearing aid microphone;
a speaker that converts the amplified sound signal applied from the hearing aid signal processor into the voice to then output the converted voice; and
a hearing aid switch that selects one of the light receptor and the hearing aid microphone, as a microphone that provides the sound signal to be amplified in the hearing aid signal processor.
